(19) United States
(12) Patent Application Publication
(10) Pub. No.: US 2003/0167646 A1
(43) Pub. Date: Sep. 11, 2003

(54) Leveling instrument

(76) Inventor: Jung Mu Lin, Taipei (TW)

Correspondence Address: LIN Jung Mu, PO Box 82-144, TAIPEI, TW

(21) Appl. No.: 10/093,391

(22) Filed: Mar. 11, 2002

(51) Int. Cl. G01C 9/12

(52) U.S. Cl. 33/391

(57) ABSTRACT

An improved structure of a leveling instrument comprised of a frame, a central fixation axis, a pendant and a lid; a leveling meter provided at the center on the outer surface of the frame; the central fixation axis penetrating through a hole in the center of the leveling meter to secure the pendant; a ball being disposed at the lower end of the pendant and a lateral bar above the ball being inserted into the pendant at a right angle to define a cross; a corresponding cross mark provided on the outer surface of the lid; the frame sealed with the lid; and the leveling of the object measured is told by the meter for the inclination then adjusted for the pendant to point to zero degree while the cross defined by the lateral bar and the pendant perfect match the cross mark provided on the lid.

### BACKGROUND OF THE INVENTION

(a) Field of the Invention

The present invention is related to an improved structure of a leveling instrument, and more particularly, to one that tells inclination for leveling adjustment.

(b) Description of the Prior Art

A conventional leveling instrument is generally comprised of a glass tube containing liquid such as alcohol and a bulb. It measures whether the surface of an object is leveled. However, it fails to tell the exact inclination of the object for precise adjustment.

Therefore, it is an object of the present invention to provide a leveling instrument which can obviate and mitigate the above-mentioned drawback.

### SUMMARY OF THE INVENTION

The primary object of the present invention is to provide an improved structure of a leveling instrument that is provided with a leveling meter attached to a frame of the instrument. While immediately indicating whether the object is leveled at a glance, the present invention tells the exact inclination for further adjustment. Such leveling meter is of simple structure and efficient to overcome the flaw of the conventional leveling instrument by giving the function and significance a leveling instrument should have.

The foregoing object and summary provide only a brief introduction to the present invention. To fully appreciate these and other objects of the present invention as well as the invention itself,- all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention;

FIG. 2 is a schematic view showing that the present invention is in use; and

FIG. 3 is a perspective view showing an assembly of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

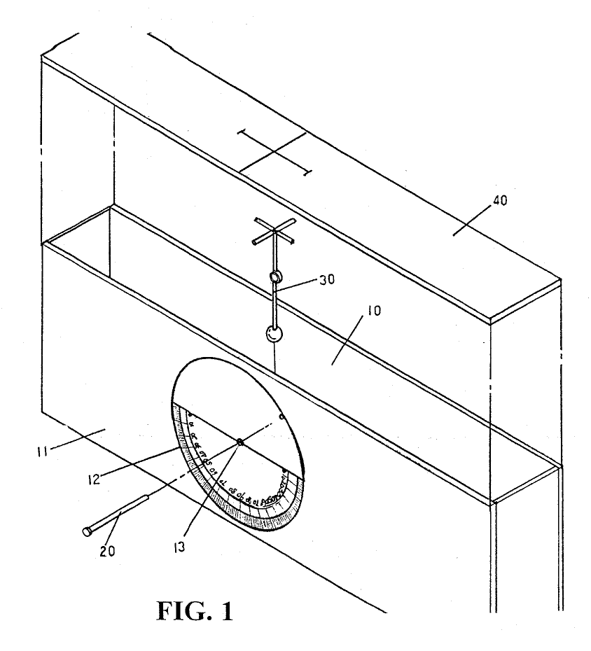

Referring to FIG. 1, a preferred embodiment of the present invention is essentially comprised of a leveling frame (10), a central fixation axis (20), a dependant (30) and a lid (40). Wherein, a leveling meter (12) is provided at the center of the outer surface (11) of the frame (10). The central fixation axis (20) is inserted through a hole (13) provided in the center of the leveling meter (12) to secure the pendant (30). The frame (10) is then sealed up with the lid (40).

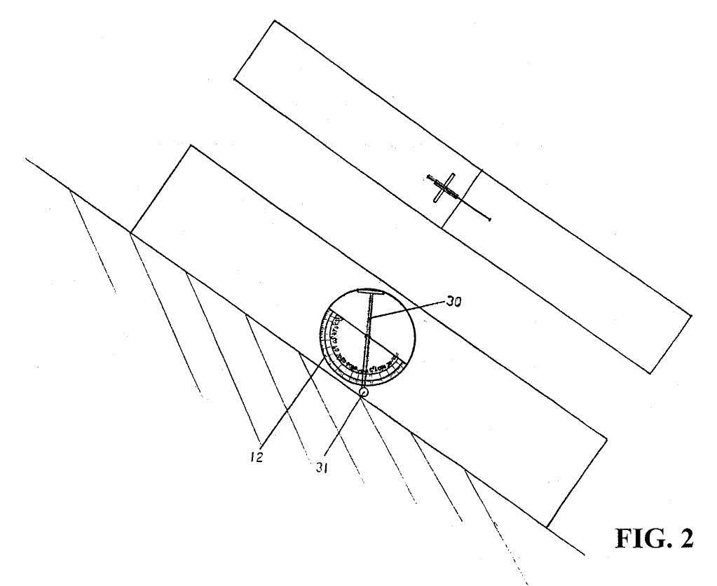

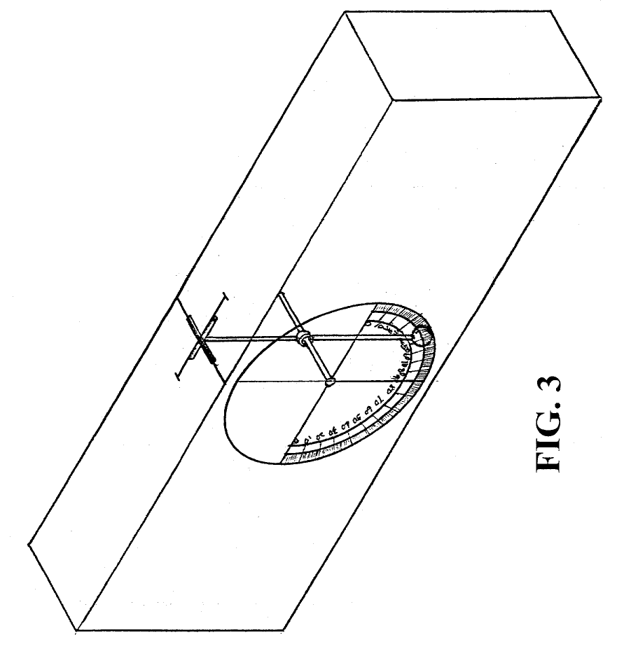

As illustrated in FIG. 2, a ball (31) attached to the lower end of the pendant (30) is always at a right angle to a horizontal plane due to gravity. The angle formed by the object to be leveled and the pendant (30) relates to the inclination of the leveling instrument. Therefore, the level of the object is adjusted according to the inclination told by the leveling meter (12). Now referring to FIG. 3 for an assembly of the preferred embodiment of the present invention, the leveling meter (12) attached to the outer surface (11) of the frame (10) is scaled. A lateral bar (32) is inserted through the pendant (31) at where above the ball (31) and a corresponding cross (41) is provided on the lid (41). Once the pendant (30) is at a location for the leveling meter (12) to tell a zero degree, and the cross defined by the lateral bar (32) and the pendant (30) is overlapped with the cross (41) on the lid (40), the leveling instrument is leveled. By correcting the flaw of failing to provide any digital basis to tell inclination as observed with the conventional leveling bulb, the present invention provided with the leveling meter (12) on the outer surface (11) of the frame (10) to tell whether an object measured is leveled at a glance. Meanwhile, it tells the exact inclination for further adjustment. Such leveling meter is of simple structure and efficient to overcome the Raw of the conventional leveling instrument by giving the function and significance a leveling instrument should have.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a leveling instrument, essentially comprised of a frame, a central fixation axis, a pendant and a lid characterized by that a leveling meter being provided at the center on the outer surface of the frame, the central fixation axis penetrating through a hole in the center of the leveling meter to secure the pendant; a ball being disposed at the lower end of the pendant and a lateral bar above the ball being inserted into the pendant at a right angle to define a cross; a corresponding cross mark being provided on the outer surface of the lid and the frame is sealed with the lid so for the leveling meter to tell the inclination in conjunction with the pendant which being always kept vertically due to the force of the central gravity.
